(19) United States
(12) Patent Application Publication
(10) Pub. No.: US 2015/0080069 A1
(43) Pub. Date: Mar. 19, 2015

(54) Arrangement for Loss Measurement in a Combine Harvester

(71) Applicants: Volker Fuchs, Saarburg (DE); Philipp Wilde Von Wildemann, Maulbronn (DE); Douglas J. Bollin, Kaiserslautern (DE)

(72) Inventors: Volker Fuchs, Saarburg (DE); Philipp Wilde Von Wildemann, Maulbronn (DE); Douglas J. Bollin, Kaiserslautern (DE)

(21) Appl. No.: 14/448,754

(22) Filed: Jul. 31, 2014

(30) Foreign Application Priority Data
Jul. 31, 2013 (DE) 102013214984.0

(51) Int. Cl. A01D 41/127

(52) U.S. Cl. CPC A01D 41/1272
USPC 460/1

(57) ABSTRACT

An arrangement for loss measurement in a combine harvester (10, 10′) comprises a grain flow sensor (68, 68′, 68″, 68a, 68b) for detecting the intensity of a grain flow separated out in a separating apparatus of the combine harvester (10, 10′) and a monitoring device (74) for calculating a grain loss value on the basis of signals from the grain flow sensor (68, 68′, 68″, 68a, 68b). The grain flow sensor (68, 68′, 68″, 68a, 68b) is associated with a conveying apparatus for grain arranged between the separating apparatus and a cleaning apparatus (46).

### RELATED APPLICATIONS

This application claims priority under 35 USC §119 from DE 102013214984.0 which was filed on Jul. 31, 2013.

### FIELD OF THE INVENTION

The invention pertains to an arrangement for loss measurement in a combine harvester, with a grain flow sensor for detecting the intensity of a grain stream separated out in a separating apparatus of a combine harvester and a monitoring unit for calculating a grain loss value on the basis of signals from the grain flow sensor.

### BACKGROUND OF THE INVENTION

Combine harvesters are used for harvesting grain and other seeds. Plants standing or lying on a field are cut off or picked up by a harvesting head and transported by means of an inclined conveyor into the interior of the combine harvester. There the plants are threshed and fed to a separating system. Grain separated out in the separating process is cleaned in a cleaning system and temporarily deposited in a grain tank in order to be subsequently loaded into a transport vehicle.

The threshing process is usually carried out by means of a tangential threshing drum or in the threshing section of an axial threshing and separating rotor. The separating process is usually carried out by means of separating drums and a straw shaker of a tangential multi-drum threshing unit or by means of a separating rotor situated downstream of a tangential threshing mechanism, or in the separating section of an axial threshing and separating rotor. At the end of the separating process, the threshed straw is either deposited as a swath on the field, to be picked up and pressed into bales by a baler, or is directed through a straw chopper, in order to then be spread onto the field.

A certain amount of grain remains in the straw and is ejected onto the field. This causes undesired losses that reduce the yield and also result in subsequent vegetation due to sprouting grain. It is therefore desirable to detect the amount of lost grain in the straw at the end of the separating process in order to take countermeasures if necessary, such as a reduction of the travel speed or a modified setting of the threshing and/or separating equipment. In the prior art, a baffle plate sensor, which detects the noise generated by the impact of lost grain, was installed for this purpose at the rear end of the straw shaker (DE 24 48 745 A1). It is considered disadvantageous in this case that the measurement values are relatively imprecise, because the number of detectable grains is relatively small if the combine harvester has been properly adjusted and is operating properly, and the grains are largely embedded in the straw and are therefore not detected by the baffle plate sensor. Therefore a calibration is usually initially performed, in which the indicated values of a loss indicator device and the actual losses on the field are detected, e.g. by means of a loss testing bowl, and the user then travels at a speed that leads to an acceptable loss.

As a solution to this problem, U.S. Pat. No. 4,951,031 proposes equipping the threshing and separating apparatus with a plurality of grain flow sensors that detect the respective quantity of separated grains at each of the positions along the path of the crop though the threshing and separating apparatus. A separation curve is calculated based on the measurement values, in order to be able to recognize situations in which a high proportion of grain is separated in the rear area of the separating apparatus. Based on experience, there are also high losses in these situations, because the straw in the rear part of the separating apparatus still contains a relatively large amount of grain, which is finally ejected onto the field, at least in part. A similar arrangement is found in DE 101 62 354 A1. Because of the limited dimensions of the grain flow sensors in this case, they detect only relatively small portions of the grain, which are not always representative enough to supply sufficiently precise indications of losses.

The problem addressed by the present invention is considered to be that of providing a loss measurement arrangement in a combine harvester that does not have the above problems or has them only to a limited extent.

This problem is solved according to the invention by the teaching of the independent claim (or claims), while characteristics that further develop the invention in an advantageous manner are specified in the additional claims.

### SUMMARY OF THE INVENTION

In accordance with one aspect of the invention, an arrangement for loss measurement in a combine harvester comprises a grain flow sensor for detecting the intensity of a grain stream separated out in a separating apparatus of a combine harvester and a monitoring unit for calculating a grain loss value on the basis of signals from the grain flow sensor. The grain flow sensor is associated with a conveying apparatus for grain arranged between the separating apparatus and a cleaning apparatus.

The conveying apparatus collects the material (grain) separated by the separating apparatus and transports it to the cleaning apparatus. The grain flow sensor is located in a section of the path of the material through the conveying apparatus. The grain flow sensor thus detects the collected material that is conveyed by the conveying apparatus from the separating apparatus. This has the effect that the grain flow sensor is exposed to a larger material flow than in the prior art, in which the sensor detects only the losses at the outlet of the separating apparatus or only a material stream striking it directly from the separating apparatus. Thus a stronger and more reliable signal is provided by the grain flow sensor, which allows the determination and display of a more reliable loss value than previously.

The grain flow sensor can detect the grain flow downstream of the conveying apparatus or inside the conveying apparatus. More particularly, it can be arranged downstream of or inside a conveyor bottom or a return pan of the separating apparatus. The separating apparatus can comprise a straw shaker or a separating rotor.

The monitoring device is preferably connected to a total grain flow sensor for detecting the total grain flow in the combine harvester, and determines the grain loss value on the basis of the signals from the grain flow sensor and the total grain flow sensor. For this purpose, loss curves or tables corresponding to different total grain flows, on the basis of which the monitoring unit can determine the respective loss for a given grain stream, can be stored in the monitoring unit.

In accordance with another aspect of the invention, an arrangement for loss measurement in a combine harvester (10, 10′) is provided, comprising a grain flow sensor (68, 68′, 68″, 68a, 68b) for detecting an intensity of a grain flow separated in a separating apparatus of the combine harvester (10, 10′); and a monitoring device (74) for calculating a grain loss value on a basis of signals from the grain flow sensor (68, 68′, 68″, 68a, 68b); wherein the grain flow sensor (68, 68′, 68″, 68a, 68b) is associated with a conveying apparatus arranged between the separating apparatus and a cleaning apparatus (46).

The grain flow sensor may be configured to detect the grain flow downstream of the conveying apparatus or inside the conveying apparatus.

The grain flow sensor may be arranged downstream or inside a conveying floor (42) or a return pan (70) of the separating apparatus.

The separating apparatus may comprise a straw shaker or a separating rotor.

The monitoring device may be connected to a total grain flow sensor (78) for detecting a total grain flow in the combine harvester (10, 10′) and maybe operable to determine the grain loss value based upon a signal from the grain flow sensor (68, 68′, 68″, 68a, 68b) and a signal from the total grain flow sensor (78).

The monitoring device may be connected to two grain flow sensors (68, 68′, 68″, 68a, 68b) arranged at different points of the conveying apparatus and may be operable to determine a separation curve based upon signals from the two grain flow sensors (68, 68′, 68″, 68a, 68b) and to generate a loss value based upon the separation curve.

In accordance with another aspect of the invention, a combine harvester comprises a threshing device, a separating apparatus, a cleaning apparatus (46) and an arrangement for loss monitoring.

### BRIEF DESCRIPTION OF THE DRAWINGS

Two embodiments of the invention, to be described below, are shown in the drawings, in which:

FIG. 1 shows a schematic side view of a first embodiment of a combine harvester with an arrangement for loss measurement according to the invention.

FIG. 2 shows a schematic side view of a second embodiment of a combine harvester with an arrangement for loss measurement according to the invention.

### DETAILED DESCRIPTION OF THE PREFERRED EMBODIMENTS

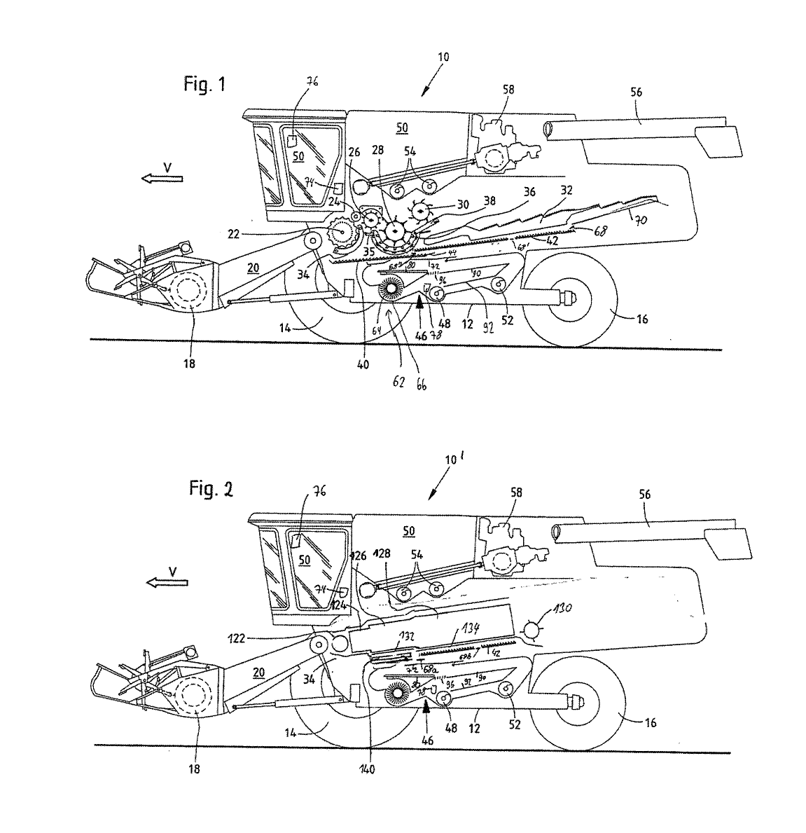

FIG. 1 shows a self-propelled combine harvester 10 with a frame 12 that is supported on the ground via driven front wheels 14 and steerable rear wheels 16 and propelled thereby. The driven front wheels 14 are driven by drive means, not shown in detail, in order to move the combine harvester 10, for example, on a field to harvested. Directional indications such as front and rear refer below to the travel direction V of the combine harvester 10 during harvesting operation.

A crop uptake device 18 in the form of a cutting mechanism is removably connected to the front end area of the combine harvester 10, in order to harvest crop in the form of grain or other threshable crops from the field and feed it upwards and to the rear by means of an inclined conveyor 20 to a multi-drum threshing mechanism that comprises—arranged in succession in the travel direction V—a threshing drum 22, a stripper drum 24, an overshot drum conveyor 26, a tangential separator 28 and a turning drum 30. Downstream of the turning drum 30 is a straw shaker 32 with a plurality of straw walkers arranged laterally one next to the other. In its lower and rear area, the threshing drum 22 is surrounded by a threshing basket 34. Underneath the conveyor drum 26 is a cover 35 with a contiguous surface or furnished with openings, while above the conveyor drum 26 is a fixedly mounted cover, and a separating basket 36 with adjustable finger elements is located underneath the tangential separator 28. A finger rake 38 is arranged underneath the turning drum 30.

A front conveying floor 40, which carries out an oscillating movement directed alternately to the front and the rear when in operation, is located underneath the multi-drum threshing mechanism. A rear conveying floor 42 is located underneath the straw shaker 32 and likewise carries out an oscillating movement directed alternately to the front and the rear. The front conveying floor 40 transports the mixture of grain and chaff passing through the threshing basket 34 and the separating basket 36 of the tangential separator 28 to the rear, while the rear conveying floor 42 transports the mixture of grain and chaff passing through the straw shaker 32 to the front. The rear conveying floor 42 transfers its mixture at its front end to the front conveying floor 40, which outputs downward through a rear finger rake 44. The mixture output by the front conveying floor 40 then reaches a cleaning apparatus 46.

The grain cleaned by the cleaning apparatus 46 is fed by means of a screw auger 48 to an elevator, not shown, which conveys it into a grain tank 50. A return auger 52 passes unthreshed head parts through an additional elevator, not shown, back into the threshing process. The chaff can be ejected at the rear side of the screen device by a rotating chaff distributor, or it is ejected by a straw chopper (not drawn) arranged downstream of the straw shaker 32. The cleaned grain can be unloaded from the grain tank 50 by a discharge system with cross augers 54 and a discharge conveyor 56.

The above-mentioned systems are driven by means of an internal combustion engine 58 and are monitored and controlled by an operator from a driver's cab 60. Various apparatuses for threshing, conveying, cleaning and separating are located inside the frame 12. An outer shell, which can be largely folded open, is located outside the frame 12.

It must be noted that the multi-drum threshing mechanism presented here is only one example of an embodiment. It could also be replaced by a single transversely oriented threshing drum and a downstream separating apparatus with a straw shaker or one or more separating rotors.

The cleaning apparatus 46 comprises a fan 62, which is composed of a rotor 64 that can be set into rotation (counterclockwise in FIG. 2) and a housing 66 surrounding the rotor 64. The cleaning apparatus 46 further comprises a pre-cleaning screen 72 with screen blades supported in a screen frame and mounted movably at an angle about their longitudinal axis, the screen being located underneath the rear finger rake 44 and extending nearly horizontally and slightly upwards from the rear edge of the front conveying floor 40.

Underneath the front half of the pre-cleaning screen 72 is a conveying floor 80, below which the upper part of the housing 66 for the fan 62 is arranged. To the rear of the conveying floor is a grating 96, which is followed by an upper screen 90 and a lower screen 92 arranged thereunder. The upper screen 90 and the lower screen 92 each comprise screen blades arranged in a frame and are adjustable independently of one another at an angle about their longitudinal axis. Further details regarding the cleaning apparatus 46 can be found in DE 10 2005 026 608 A1. Any other desired cleaning apparatus can also be used. In particular, the pre-cleaning screen 72 can be replaced by a conveying floor or a conveyor auger.

In order to determine the losses in the separating unit, which is formed in the embodiment of FIG. 1 by the tangential separator 28 and the straw shaker 32, a grain flow sensor 68 is provided, which is located underneath the front end of a return pan 70 that is located underneath the rear area of the straw shaker 32 and is used to convey grain separated there to the rear conveying floor 42. The grain flow sensor 68 is located inside a winnowing step through which the grain passes between the return pan 70 and the rear conveying floor 42. Impacting grains cause easily detectable vibrations on the grain flow sensor 68, which can be configured as a conventional baffle plate sensor.

An additionally or alternatively provided grain flow sensor 68′ is located inside the rear conveying floor 42, more particularly, roughly at the beginning of the rear third. The grain flow sensor 68′ lies in the plane of the rear conveying floor 42 and detects vibrations caused by grains impacting it during the conveying process. It can likewise be constructed as a baffle plate sensor.

An additionally or alternatively provided grain flow sensor 68″ is located inside a winnowing step through which the grain passes between the rear conveying floor 42 and the front conveying floor 40.

Impacting grains cause easily detectable vibrations on the grain flow sensor 68″, which can likewise be configured as a conventional baffle plate sensor.

The grain flow sensors 68, 68′ and/or 68″ are connected so as to transmit signals to a monitoring device 74, which is in turn connected to a display device 76. The monitoring device 74 is also connected to a total grain flow sensor 78, which is associated in the illustrated embodiment with the screw auger 48 and detects its drive torque. In a different embodiment, the total grain flow sensor 78 could detect the grain flow by photoelectric barriers in the grain elevator (not shown), which is located between the screw auger 48 and the grain tank 50.

During harvesting operation, the monitoring device 74 receives signals from one or more of the grain flow sensors 68, 68′ or 68″. These signals are generated by a relatively large integrated upstream and downstream flow of grain through the return pan 70 and the rear conveying floor 42 or inside the rear conveying floor 42 and are therefore quite reliable. Signals regarding the grain separated in the rear third (grain flow sensor 68) or in the rear two thirds (grain flow sensor 68′) or in the entire straw shaker 32 (grain flow sensor 68″) are thus applied to the monitoring device 74. These signals are calculated by the monitoring device 74 into loss values. For this purpose, loss curves associated with different overall grain flows detected by the total grain flow sensor 78 can be called up from the memory of the monitoring device 74, and the current loss value for the signal of the grain flow sensor (68, 68′ or 68″) can be read out from the respective applicable loss curve and displayed on the display device 76. Alternatively or additionally, the monitoring device 74 can be connected to two grain flow sensors arranged at different points in the conveying apparatus (e.g. 68 and 68′ and/or 68″, or 68′ and 68″) and a separation curve can be generated on the basis of the signals of the different grain flow sensors, and a loss value can be generated on the basis of the separation curve. The reader is referred to the prior art from U.S. Pat. No. 4,951,031 A and DE 101 62 354 A1 in this regard.

It would also be conceivable to further connect the monitoring device 74 to conventional loss sensors for the cleaning, in order to also be able to display cleaning losses (and/or a cumulative loss value) on the display device 76.

In the embodiment of the combine harvester 10′ according to FIG. 2, elements corresponding to the first embodiment are labeled with the same reference numbers. The essential difference is that the multi-drum threshing mechanism with the downstream straw shaker 32 was replaced by an axial threshing and separating rotor. The crop material is fed by the inclined conveyor 20 to a conveying drum 122, which feeds the crop material in an overshot manner to an inlet transition section 124 of the axial threshing and separating rotor. A threshing section 126 and a separating section 128 of the axial threshing and separating rotor follow the inlet transition section 124 in the downstream direction. The threshed straw is ejected by an ejection drum 130 or supplied to a straw chopper (not shown). The reader is referred to EP 2 055 176 A1 for further details.

A threshing basket 132 is arranged underneath the threshing section 126, and a separating grating 134 is arranged underneath the separating section 128. A screw conveyor 140 conveys the grain falling downwards through the threshing basket 132 to the rear and onto the pre-cleaning screen 72, while the rear conveying floor 42 conveys the crop falling downwards through the separating grating 134 and outputs it to the pre-cleaning screen 72 in a winnowing step, in which a grain flow sensor 68a is arranged. An additional or alternative grain flow sensor 68b is mounted in the rear third of the rear conveying floor 42, analogously to the grain flow sensor 68′ of FIG. 1.

In this embodiment, the grain flow sensor 68a thus detects the entire grain flow separated by the separating apparatus, which is formed by the separating section 128 and the separating grating 134. The grain flow sensor 68b approximately detects the grain flow separated in the rear third of the separating apparatus. The mode of operation of the arrangement for loss measurement with the monitoring device 74, the display device 76, the grain flow sensor 68a and/or 68b and the total grain flow sensor 78 corresponds to that of the embodiment according to FIG. 1.

1. An arrangement for loss measurement in a combine harvester (10, 10′) comprises a grain flow sensor (68, 68′, 68″, 68a, 68b) for detecting an intensity of a grain flow separated in a separating apparatus of the combine harvester (10, 10′); and a monitoring device (74) for calculating a grain loss value on a basis of signals from the grain flow sensor (68, 68′, 68″, 68a, 68b); wherein the grain flow sensor (68, 68′, 68″, 68a, 68b) is associated with a conveying apparatus arranged between the separating apparatus and a cleaning apparatus (46).

2. The arrangement according to claim 1, wherein the grain flow sensor (68, 68′, 68″, 68a, 68b) is configured to detect the grain flow downstream of the conveying apparatus or inside the conveying apparatus.

3. The arrangement according to claim 2, wherein the grain flow sensor (68, 68′, 68″, 68a, 68b) is arranged downstream or inside a conveying floor (42) or a return pan (70) of the separating apparatus.

4. The arrangement according to claim 3, wherein the separating apparatus (32) comprises a straw shaker or a separating rotor.

5. The arrangement according to claim 1, wherein the monitoring device (74) is connected to a total grain flow sensor (78) for detecting a total grain flow in the combine harvester (10, 10′) and is operable to determine the grain loss value based upon a signal from the grain flow sensor (68, 68′, 68″, 68a, 68b) and a signal from the total grain flow sensor (78).

6. The arrangement according to claim 1, wherein the monitoring device (74) is connected to two grain flow sensors (68, 68′, 68″, 68a, 68b) arranged at different points of the conveying apparatus and is operable to determine a separation curve based upon signals from the two grain flow sensors (68, 68′, 68″, 68a, 68b) and to generate a loss value based upon the separation curve.

7. A combine harvester (10), comprising a threshing device, a separating apparatus, a cleaning apparatus (46) and the arrangement according to claim 1.
